(19) United States
(12) Patent Application Publication
(10) Pub. No.: US 2008/0027789 A1
(43) Pub. Date: Jan. 31, 2008

(54) Generating a View of Measured Performance

(76) Inventors: Carsten Busch, Weinheim (DE); Ingrid Van Skyhawk, Muelhausen (DE)

Correspondence Address: FISH & RICHARDSON, P.C., PO BOX 1022, MINNEAPOLIS, MN, 55440-1022, US

(21) Appl. No.: 11/461,409

(22) Filed: Jul. 31, 2006

(51) Int. Cl. G06F 11/34

(52) U.S. Cl. 705/11

(57) ABSTRACT

Computer user interface views provide information regarding performance. A method of configuring such a view includes receiving user-initiated input that identifies an area within an organization and a type of information for which a performance information visual display is to be provided. The method further includes receiving user-initiated input that defines a rule to be executed in providing the performance information display. The rule includes an identification of a source for data to be retrieved relating to the identified type of information for the identified organization area, a definition of one or more performance measures against which the data retrieved from the data source are to be measured, and a definition for a display layout for the performance information display. The method further includes electronically storing the defined rule in association with the identified organization area and the identified type of information, for use in generating the performance information display.

### TECHNICAL FIELD

This invention relates to planning, and more particularly to measuring the performance of a business area.

### BACKGROUND

The structure of a business enterprise may be dynamic and undergo significant change over time, as sectors merge or are phased out, clients are gained and lost, and the business tries to maintain balance under the weight of unpredictable economic forces. As a result, measuring the performance of a business or a business sector at any given time may be a very complex, time-consuming task. One of the functions of a business manager or corporate executive may involve monitoring the performance of a particular business area, such as a sales or finance division, or several different business areas. This may involve scrutinizing performance indicators of the enterprise area they oversee, so as to become cognizant of problems if they arise and react quickly to resolve any issues.

For enterprises with multiple sectors, sub-sectors, or divisions, measuring performance may involve lengthy analysis of enterprise data, and may often times be delayed while reports are compiled across various business areas by multiple personnel. If a manager or executive of a particular business sector requires a real-time measure of their productivity or performance, the persons responsible for collecting that type of data may have to halt their current function, create the requested performance analysis, and send it to the manager or executive, who may then decipher the results. This may be a time-consuming endeavor, and one in which enterprise productivity may be slowed for the sake of measuring same.

Examination of enterprise performance may involve many levels of granularity, which may produce confusing conclusions if the granularity is not readily transparent. For example, underperformance in one business sub-sector may outweigh positive performance in another, making the sector as a whole look as if it is not performing to expected levels. Trouble areas within a business area may be hard to pinpoint, which may be exacerbated by the time and resources it takes for performance reports to be compiled and analyzed.

### SUMMARY

This document discloses methods, systems, and computer program products for configuring and then generating at run-time a computer user interface view that provides information regarding performance, for example, of a business organization.

In one aspect, this document discloses a computer-implemented method for configuring a process to be executed to provide a visual display showing performance information for an organization, as well as systems and computer program products that are used in executing the method. The method includes receiving user-initiated input that identifies an area within an organization and a type of information that is applicable to the identified organization area and for which a performance information visual display is to be provided. The method further includes receiving user-initiated input that defines a rule to be executed in providing the performance information display. The rule includes an identification of a source for data to be retrieved relating to the identified type of information for the identified organization area, a definition of one or more performance measures against which the data retrieved from the data source are to be measured, and a definition for a display layout for the performance information display. The method further provides for electronically storing the defined rule in association with the identified organization area and the identified type of information, for use in generating the performance information display.

In various implementations of the computer-implemented method, one or more of the following features may be included. The data source may be a specified electronic document in which at least a portion of the data relating to the identified type of information for the identified organization area are stored during operations of the organization area. In this case, the data source may also include a specified portion of the specified electronic document. In addition or alternatively, the specified electronic document may comply with a predefined format that ensures relevant data are stored in the specified electronic document during operations of the organization area.

In the method, the performance measures may include a limit boundary that defines a limit for different specified performance levels. In this case, the limit boundary may be a target performance level, and the different specified performance levels may indicate a performance achieved in comparison with the target performance level.

The display layout, in the method, may be a graphical representation of the retrieved data from the identified data source as compared with the defined one or more performance measures. Where this is the case, the performance measures may include a limit boundary that defines a limit for different specified performance levels. The limit boundary may be, for example, a target performance level, and the different specified performance levels may indicate a performance achieved in comparison with the target performance level.

In another aspect, this document discloses a method for generating a visual display showing performance information for an organization, as well as systems and computer program products that are used in executing the method. The method includes receiving user-initiated input that requests a performance visual display be provided for an area within an organization and a type of information that is applicable to the identified organization area for which a performance information visual display has been pre-configured. The method further includes retrieving data relating to the type of information for the organization area from a predefined data source. The method further includes generating, on a display device, a visual display of the retrieved data measured against one or more predefined performance measures and within a predefined display layout for the performance information display.

In various implementations of the method of generating the visual display, one or more of the following features may be included. The data may include a specified electronic document in which at least a portion of the data relating to the identified type of information for the identified organization area are stored during operations of the organization area. In this case, the data source may further include a specified portion of a specified electronic document. Additionally or alternatively, the specified electronic document may comply with a predefined format that ensures relevant data are stored in the specified electronic document during operations of the organization area.

In addition, the performance measures may include a limit boundary that defines a limit for different specified performance levels. The limit boundary may be a target performance level, and the different specified performance levels indicate a performance achieved in comparison with the one or more predefined performance measures.

The visual display may be a graphical representation for the retrieved data from the predefined data source as compared with the defined one or more performance measures. In this case, the performance measures may, as described for other implementations, include a limit boundary that defines a limit for different specified performance levels. Again, the limit boundary may be a target performance level, and the different specified performance levels indicate a performance achieved in comparison with the one or more predefined performance measures.

In addition, the visual display of the retrieved data may be presented in a universal display format, independent of a user's hierarchical standing with the organization that requests the performance visual display.

In other aspects, computer program product are provided that are tangibly embodied in an information carrier. The computer program products include instructions that, when executed, perform operations for executing the above-described method. In yet further aspects, systems are provided that enable the above-described methods to be carried out.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of an exemplary enterprise computing system 100 that may be used to generate a performance view.

FIG. 2 contains elements of an exemplary enterprise key area hierarchy 200.

FIG. 3 is a flowchart 300 that describes the general sequence of events for setting up a performance view according to one implementation.

FIG. 4 is a flowchart 400 that describes the general sequence of events when a user executes a request for a performance view according to one implementation.

FIG. 5 is a flowchart that expands on step 327 from FIG. 3, and outlines the steps for defining a custom, or new rule.

FIG. 6 is an exemplary screen snapshot 600 of an interface used to select rules to apply to a performance view request, according to one implementation.

FIG. 7 is an exemplary screen snapshot 700 that may allow a user to select a key area for a new rule, according to one implementation.

FIG. 8 is a screen snapshot 800 of the “define conditions” portion of setting up a custom or new rule, according to one implementation.

FIG. 9 is a screen snapshot 900 of a “define characteristic details” portion of setting up a new rule, according to one implementation.

FIG. 10 is a screen snapshot 1000 of a “define properties” portion of setting up a new rule, according to one implementation.

FIG. 11 is a screen snapshot 1100 of an “identification” portion of setting up a new rule, according to one implementation.

FIG. 12 is a screen snapshot 1200 of an “assign reports” portion of setting up a new rule, according to one implementation.

FIG. 13 is a screen snapshot 1300 of a “review” portion of setting up a new rule, according to one implementation.

FIG. 14 is a screen snapshot 1400 of an exemplary performance view, according to one implementation.

FIG. 15 is a schematic diagram of a generic computer system that may be used to implement the methods described, according to one implementation.

Like reference symbols in the various drawings indicate like elements.

### DETAILED DESCRIPTION

Enterprise managers may wish to be constantly aware of the most current performance of their business areas so that they are able to react as quickly as possible to problems that may arise. The various business areas that make up an enterprise may have criterion for what may constitute performance problems that may differ from other business areas. For example, a drop in sales below a certain threshold level for a particular product may be particularly alarming for a sales manager, whereas this information would not necessarily concern a financing manager.

This document describes computer-implemented methods, as well as computer program products and systems, for creating a central point of access for viewing enterprise performance, where a manager of a business area may view up-to-date, customized views of performance status for selected areas, as well as aggregated views of the data that comprise the status of performance. Indicators of key area performance are established via a set of user-customizable rules that are used for analyzing user-specified data collected during run-time. Together, a key area view and a pre-analysis view containing graphical portrayal of performance data comprise a “performance view.”

Typically, managers of an enterprise area are responsible for one or more facets of the area, for example, a sales manager may be responsible for monitoring the performance of sales data (e.g., quarterly sales figures), processes (e.g., number of quotes generated by salespersons), and customers (e.g., number of new customers gained per quarter). These ‘key areas’ may define a scope of manager responsibility within the enterprise, and the manager may require constant updates on the performance of each key area. Data that determine the performance of key areas may exist, for example, in documents, spreadsheets, or program files generated by CRM or ERP software solutions, and may be maintained by one or more subordinate employees relative to the area manager.

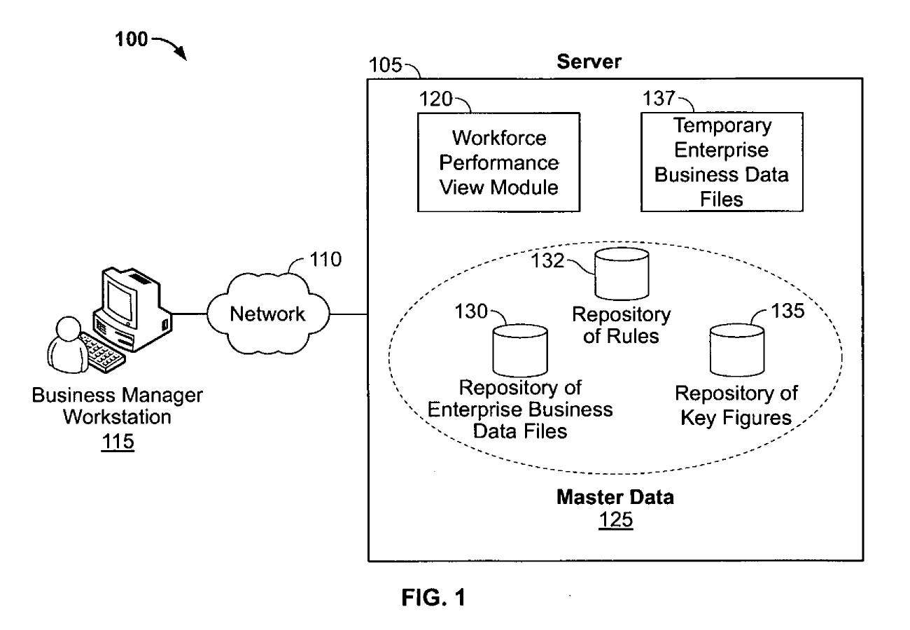

FIG. 1 is a diagram of an exemplary enterprise computing system 100 that may be used to generate a performance view. In general, the system 100 may comprise an enterprise computing system server 105 on which computer software applications 107 and data generated from those applications 130, 137 may be stored. The server 105 is accessible by one or more client systems 115 via network connections 110 that are able to make use of the applications and data stored on the server 105. The server 105 includes a server-based workforce performance view (WPV) software module 120 which may be accessed by the client system 115 in carrying out the process of generating a particular WPV. The WPV module 120 is comprised of computing instructions that can be executed by a processor (not shown in FIG. 1) residing, for example, within the server 105, to generate a performance view.

In general, the WPV module 120 may search for and retrieve pre-identified enterprise master data 125 (e.g., finalized spreadsheet files) or temporary data 137 (e.g., spreadsheet files in unfinished form) on the server 105 that relates to a particular business area. The master data 125 or temporary data 137 may be comprised of files generated from various enterprise software packages 107. In a particular embodiment, software packages may include Customer Resource Management (CRM) or Enterprise Resource Planning (ERP) applications, and master data 125 and temporary data 137 may include spreadsheets or database files generated by the applications 107. Users may typically be managers in charge of a particular business area.

The system server 105 may contain repositories of rules 132 and data corresponding to performance elements of key figure areas 135. Key figures 135 can be master data that reflect performance factors for a key area of a user. Key areas can reflect the main business areas of an enterprise, such as financials, customers, processes, and innovations. Rules 132 can be customizable master data that define the location of business data that will be collected and analyzed, as well as the parameters for defining levels of performance and methods for comparing the collected data to the defined performance level. For example, a user may set a tolerance level to indicate whether the performance of a key area is within acceptable boundaries.

During execution, the performance view module 120 may collect data from temporary data files 137 and master data enterprise business data files 135, analyze the data according to the predefined rules, and produce detailed, aggregated views reflecting the performance of individual key areas. The visual aspects of the view module 120 may be tailored to a user's personal preferences through customization steps (described below) performed during the creation of rules.

In an exemplary embodiment, a manager 115 may access a configuration portion of the WPV module 120 to select the business areas relevant to their particular area of responsibility from a repository of key figures 150. Once a key area is selected, the manager may select from one or more configurable rules 132 to apply to their view and customize it according to their particular needs. An example rule 132 may include a performance boundary on “Gross Sales Revenue (GSR)” in a “Financials” key area. In this example, the user 115 may personalize the GSR rule such that threshold limits are applied to the GSR data. The manager may configure the rule 132 so as to display a “medium” status if the key area GSR falls below 90% for the Financials key area; the manager may further set a “critical” status indicator if the key area GSR falls below 50%.

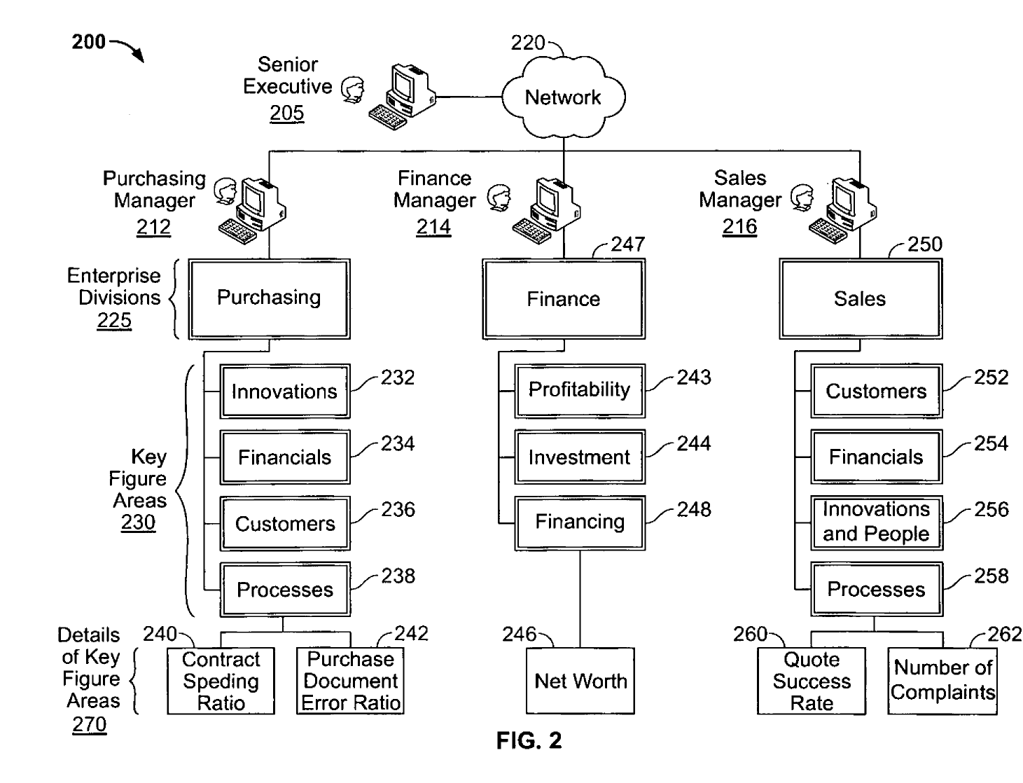

FIG. 2 contains elements of an exemplary enterprise key area hierarchy 200. At the top of the hierarchy 200 is a senior executive 205 who may oversee the performance of the entire enterprise. Beneath the senior executive 205 are several managerial positions 210, including, e.g., a purchasing manager 212, a finance manager 214, and a sales manager 216. Network connections 220 allow data to be shared among one another in the business hierarchy 200.

Exemplary key figure areas 230 are listed below each managerial position for which the respective manager has direct responsibility for in the business of the enterprise. For example, the purchasing manager 212 may be responsible for the performance of Innovations 232, Financials 234, Customers 236, and Processes 238 groups. At the bottom of the exemplary enterprise hierarchy 200, the key figures areas 230 are broken down into further denominations representing the details of key figure areas 270. For example, the Processes 238 key figure area may be represented by indicators such as a Contract Spending Ratio 240 and a Purchase Document Error Ratio 242. Likewise, Net Worth 246 may be used as an indicator in the Financing 248 key figure area, for which the Finance Manager 214 has direct culpability. Key areas may include business perspectives, as, for example with the enterprise division Finance 247. The perspectives within the Finance division 247 can include profitability 243, investment 244, and financing 248, for example.

In general, the WPV module may be executed by a user to generate a performance view of any of the key figure areas 230 under their jurisdiction. In a particular embodiment, the sales manager 216, for example, may wish to examine the performance of the Sales 250 enterprise division as a whole. The sales manager 216 may use pre-defined rules to aid in defining the parameters of what he perceives as acceptable and unacceptable performance in his division. For example, the overall performance of the sales division 250 may depend on the performance of the key figure areas in the sales division, and may be comprised of customers 252, financials 254, innovations and people 256, and processes 258 groups. The performance of the processes 258 key area may be dependent on the performance of quote rate success 260 and number of complaints 262 elements.

Furthering this example, the sales manager 216 may determine that in order for the sales division 250 to reflect an ‘acceptable’ performance indicator, each of the key areas under his command must be operating at 75% of a target objective. For example, the customers group 252 may have a target goal of 50 new customers per quarter; gaining 40 new customers would indicate a positive performance indicator. Upon executing a request for a performance view, the WPV module may access files within the sales division 250 hierarchy, collect the data within the files, and use that data to generate a view to the manager 216. The view may comprise a high-level overview, and overviews of each of the key figure areas and associated details, as will be discussed below. In a particular embodiment, the manager WPV module may generate a performance view that indicates whether the customers 252, financials 254, innovations and people 256 and processes 258 groups are failing within acceptable performance levels for their respective areas.

In another embodiment, the senior executive 205, having authority over the entire enterprise 200, may wish to generate a performance view that indicates the efficacy of his business. In this case, the executive 205 may execute the WPV module and generate a performance view comprising performance of the three main divisions of the enterprise 225. Senior executives 205 may be interested in a ‘birds-eye’ view of the performance of the enterprise divisions 225 and not particularly concerned with the details 270 of the key areas. The WPV module may collect data to include the details 270 of each key figure area 230 and use this data in calculating performance levels, but present the performance view in such a way that the senior executive 205 is not unduly burdened by details.

In yet another embodiment, a manager may be responsible for more than one enterprise division 225; or, a manager may be granted access to another manager's subordinate key figure areas 230. For example, the purchasing manager 212 may work closely with the sales manager 216, as is often the case. The purchasing manager 212 may wish to view the performance of the sales enterprise division 250, for example, if the enterprise was offering special deals to customers. Expecting an increase in sales, and preparing for a larger than usual stock movement, the purchasing manager 212 may wish to view the performance of the financials 254 key figure area under the sales 250 enterprise division. The purchasing manager 212 may then adjust their purchasing practices to better match the sales activity according to the performance indicator of the financials key area 254.

In yet another embodiment, the purchasing manager 212 may be working with a sales manager 216 in determining lackluster performance for the overall enterprise 200. The purchasing manager may execute the WPV module to generate performance views within the sales division 250 to hunt down the cause of the performance decline. The purchasing manager 212 may find a performance indicator within the processes 258 key figure area, and may drill down into the details of the key figure area to discover that the number of complaints 262 has increased over a particular time period. In this manner, the two managers may use performance data together to pinpoint a particular issue that is causing concern within the enterprise 200.

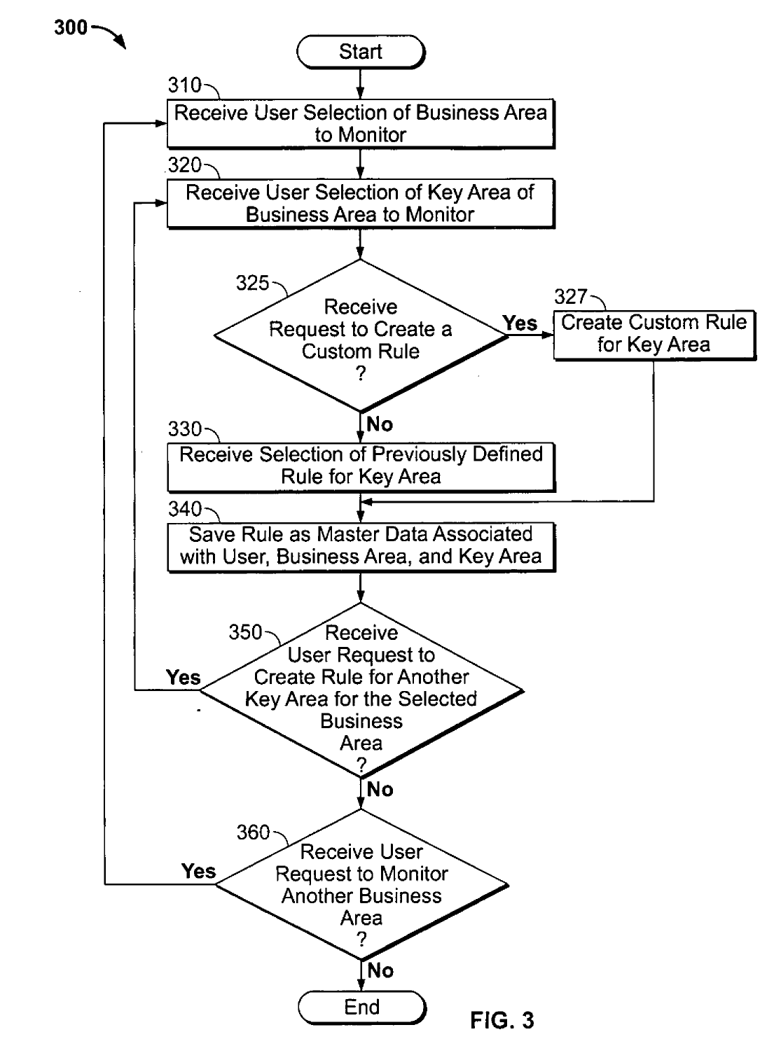

FIG. 3 is a flowchart 300 that describes the general sequence of events for setting up a performance view according to one implementation. First, at step 310, the WPV module may receive indication of a user-selected business area 225. Business areas 225 may be high-level classifications of the main sectors of a business that may comprise groups, or other sub-sectors which perform certain functions within a business. The sub-sectors within a particular business area 225 may have been pre-configured for a particular enterprise in a hierarchical structure 200, as, for example, in FIG. 2.

Next, at step 320, the WPV module 120 may receive a user-selected key business area 230 that falls within the business area chosen in step 310. The system 100 may be pre-configured such that the hierarchical structure of the enterprise 200 is defined, allowing certain key areas to be displayed to a user upon selection of a business area from step 310. For example, receiving a user selection of a ‘sales’ business area 250 may cause the WPV module to retrieve corresponding key figure areas for the sales area 250: ‘customers’ 252, ‘financials’ 254, ‘innovations and people’ 256, and ‘processes’ 258 key areas.

Subsequent steps involve the selection of rules that the user may choose to determine performance for a selected key figure area 230. In general, rules may comprise the identification of source data to be retrieved relating to a particular key area, and a definition of one or more performance measures against which the data retrieved from the data source may be measured. The rules also may define a display layout for the performance information display. Identification of source data may include identifying key area templates (e.g., spreadsheets) and fields within the templates that contain specific data relating to performance. In general, the user, through selection of appropriate rules, may determine the types of constraints, expectations, limits, and/or boundaries that will define how the WPV module determines whether or not the business area is meeting performance expectations or not.

In one implementation, the WPV module may present the user with a view containing files and folders in which pertinent data exists for the type of view requested. The user may manually select appropriate files and mark them for retrieval when the WPV module is executed. In another implementation, the user may exploit an automated search system, whereby, for example, all documents attached to a sales division created after a certain date are flagged for retrieval. In yet another implementation, a user may select all documents of a particular type; for example, spreadsheets generated by Microsoft Excel, or a particular financial software package. As an example, documents or files within a financing key area 248 may contain information relating to net worth 246. A rule may be set up such that a particular spreadsheet containing net worth data is retrieved, alone, or in conjunction with other financing data, when a performance view is requested pertaining to the ‘financing’ key area 248.

At step 325, the system 100 may receive a request to create a ‘custom’ rule, if, for example, the user requires a performance view of a key area for which a current set of available rules will not generate the required results. The user may then create a custom rule, step 327 for a particular key area. Creation of custom rules is defined in greater detail below.

If the available rules will suffice for the desired performance view, the system 100 may receive a user-defined rule for the selected key area, step 330. The user may edit parameters of the rule to suit the requirements of the particulars of the performance view. For example, a pre-existing rule may generally collect financial data in the ‘investment’ key area 244; however, a user may desire investment data corresponding to a particular time period, such as investment details over the last fiscal quarter. The user may edit the more general pre-existing rule, such that data corresponding to the appropriate dates is integrated into the rule.

When the user completes editing of a pre-existing rule, the rule can be saved as master data, step 340. The user can effect configuration of multiple rules by repeating the above process, as according to step 350. Likewise, the user can effect configuration of a performance view corresponding to the performance of multiple key areas, by repeating the above process, as according to step 360. For example, the user may execute a request for a performance view of the ‘sales’ business area 250 that comprises the performance of the key areas under the business area 250: ‘customers’ 252, ‘financials’ 254, ‘innovations and people’ 256, and ‘processes’ 258.

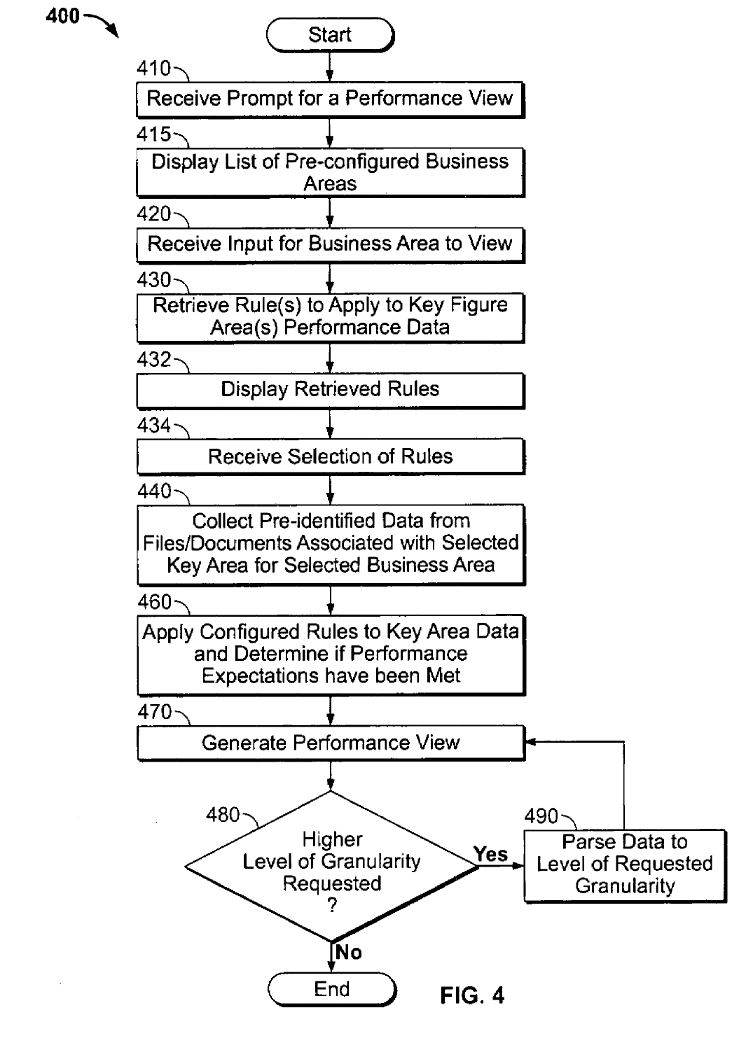

FIG. 4 is a flowchart 400 that describes the general sequence of events when a user executes a request for a performance view according to one implementation. Beginning at step 410, the system may receive a prompt for a performance view. In general, this may occur as a result of a user selecting a program icon on a client system and effecting its execution by common means, such as a mouse-click. The prompt may be sent via network connections to a location on a server where the WPV module resides, effectively establishing a communications link between the client and server for the purposes of transmitting performance view data.

Next, at step 415, the WPV module may present to the user a list of business areas for which the user has previously set up parameters for a performance view. As stated earlier, business areas may include macroscopic portions of an enterprise, such as a sales division, which themselves are made up of key areas, such as ‘customers’ and ‘financials’ within the sales division. In general, the user may have previously configured the parameters of each business area within the WPV module such that upon execution, the WPV module will seek data files specifically for the requested business area. For example, a user may determine that a specific group of employees within a ‘finance’ business area only work on finance issues within the enterprise, and do not deal with other sectors. The user may select client systems, files, folders, and/or repositories used by these employees and identify them as belonging to the ‘finance’ business area; thus, when the WPV module is executed, the WPV module may collect items in these areas for analysis of ‘finance’ performance.

The system may then receive a selection of the key areas to view, step 420. A user may select the key area by, for example, a drop-down list of preconfigured business areas, or by other common means of selection. In one embodiment, the user may perform searches for existing pre-configured key areas and select from the search results.

Next, at step 430, the system may retrieve the preconfigured rule(s) that will be used in determining the performance of the key area selected in step 420. The rules 132 may be stored as master data on a server 105. The rule(s) that the WPV retrieves may be those that are associated with the selected business area from step 420, or, the WPV may select all rules within the repository 132. In one implementation, the creation of custom rules (described below) allows for attaching the rule to a particular key areas, for example by means of a label. The WPV module may search through the rule labels to find those that are specifically meant for the selected business area and collect them for presentation to the user.

At step 432, the WPV module may display the group of rules selected at step 430 such that the user may sort through and select the rules they wish to apply to the data within the business area. At this point, the user may adjust properties of the rule(s) to fit their needs, including entering limits, values, etc., that the WPV module will use in the calculation of a performance view. At step 434, the WPV module receives the user-selected rules in the form that they will be used upon calculating the performance view.

Next, at step 440, the WPV module collects the pre-identified files/documents that correspond to the key business area identified from step 420. In general, the WPV module may collect any file/document pertaining to the requested performance view of a selected business area, including temporary files. One aspect of the system 100 is that performance views may be requested for a business area at any time, which may necessitate utilizing data contained in an incomplete, or temporary file. Temporary or incomplete files may originate from, for example, enterprise area projects, such as computing sales figures for the year, which may take considerable time to accomplish. Identifiable data within the files may be used by the WPV module such that the performance view generated contains the most up-to-date information for a particular business area.

At step 460, the rules received at step 434 may be applied to the data collected in step 440. In general, each pre-configured rule may be assigned individual criterion that defines how the rule is to be processed by the WPV module. The WPV module may calculate performance parameters of the business area key figures based on the pre-configured rules, and aggregate the data used in the calculation for display to the user. The user may assign attributes to certain rules such that alerts may be generated when performance indicators fall below certain thresholds. For example, a manager may design a rule such that a ‘warning’ graphic representing deviation from a given value accompanies the performance view of a key area if the performance of that key area is below expectations.

Performance content for the performance view may then be generated, step 470, wherein each of the selected key areas within a selected business area are displayed on a client system. In general, the performance view may include multiple window areas comprising key figure indicators of performance, which may be graphical or textual in presentation, and portions of the data used to compute the performance levels. In a particular embodiment, a performance view shows two windows: an upper part with a list of key performance indicators (KPI), clustered by key figure areas, and a pre-analysis window in the lower part, which reflects the details, typically charts or tables, of the highlighted KPI above. From this performance view it is possible to navigate to the KPI catalog, the rule definition (discussed below), or to further drill down in the pre-analysis area. A user may select portions of the performance view screen to visualize aggregated data, step 480, at variable granularity levels, such that they may ‘drill-down’ into the fine details of the data, step 490.

To illustrate, referring to FIG. 2, a finance manager 214 may request a performance view on the entire ‘finance’ enterprise division 247. The resulting view may include data on the performance of the ‘profitability’ 243, ‘investment’ 244, and ‘financing’ 248 key figure areas, which the user may select individually and examine details pertaining to the respective performance ratings. If, for example, the WPV module calculated a less than acceptable performance indicator for the ‘financing’ 248 key area, the manager 214 may access the finer details within the ‘net worth’ 246 files/documents to investigate the origin of the inadequate performance.

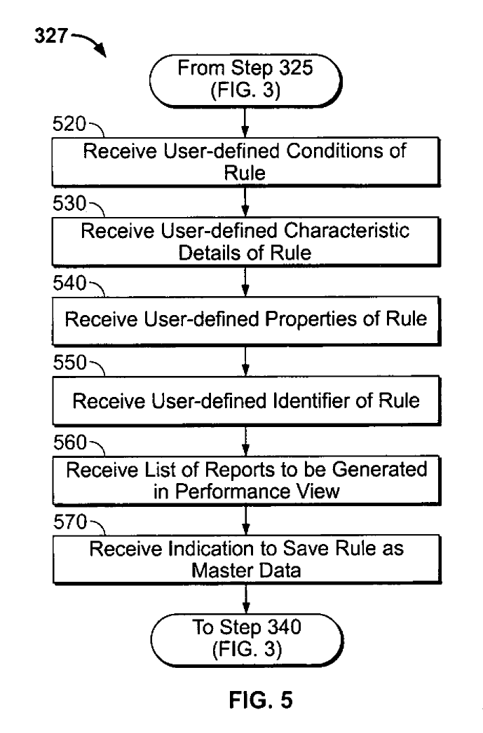

FIG. 5 is a flowchart that expands on step 327 from FIG. 3, and outlines the steps for defining a custom, or new rule. In general, a user may choose to create a new rule, for example, when one does not exist in the repository of rules 132 that will aptly perform the functions necessary for generating a desired performance view. The ability to create custom rules allows great versatility in the types of performance views that may be generated for multiple data types.

Beginning at step 510, the WPV module may receive a selected detail of a key figure area relating to a particular business area. For example, a user may wish to create a rule within the ‘financials’ key area 254 of the ‘sales’ enterprise division 250 relating to ‘Gross Sales Revenue.’ The user may request to generate a new key figure, or they may choose from blank templates of pre-configured rules comprising common formulae and performance indicators used in determining gross sales revenue. The user may input values, create descriptions, assign units of measure, etc., to define the rule.

Next, at step 520, the WPV module may receive conditions of the rule, which may be characteristics on which the rule is based. An example rule characteristic may include “value type,” or other appropriate characteristics which could be a base for measurement, and may include relative or absolute values. An example relative characteristic may be “Value type: actual is lower than Plan;” whereas an absolute characteristic may include “Value type: actual is lower than 100,000.00 USD.” The WPV module may then receive condition parameters, which may include thresholds on which the WPV module calculates whether to visually highlight that the key figure area may be in a decreased (or increased) performance state. For example, a key figure may appear as red if its status becomes critical at a user-specified level of performance, such as “gross sales revenue below 50%.” The WPV module may receive multiple conditions and characteristics per rule.

At step 530, the WPV module may receive user-selected characteristic details of the rule. These characteristics may define the level of granularity achievable in the performance view by limiting the collection or incorporation of certain data in the calculation of performance. Specifying the granularity of the measure can enable the user to reflect their special business focus. For example, a user may wish to limit a performance view in the ‘sales’ area to Gross Sales Revenue for only one out of several enterprise branches. In another example, a sales manager may want to observe a certain sales region, for example special competitive situations, new sales representatives responsible for a region, or marketing activities in the region.

Next, at step 540, the WPV module may receive user-selected property definitions for the new rule. Property definitions may include ancillary functionality, such as the ability for the WPV module to send an e-mail notification to certain personnel when performance levels are above or below a critical level. The user may also specify whether the rule may be used by other personnel. At step 550, the WPV module may receive a user-selected rule identifier, such as a rule name and a description.

Next, at step 560, the WPV module may receive user-selected reports to accompany the details of the key figure area performance data. For example, a user who is requesting a Gross Sales Revenue key figure performance view may choose year-to-date sales figures, revenues for different sales offices, or sales by product group. In one implementation, the report format may be user-customizable text or charts. Finally, at step 570, the user may be prompted to review the data entered during the preceding steps, and save the rule as master data in a repository 132.

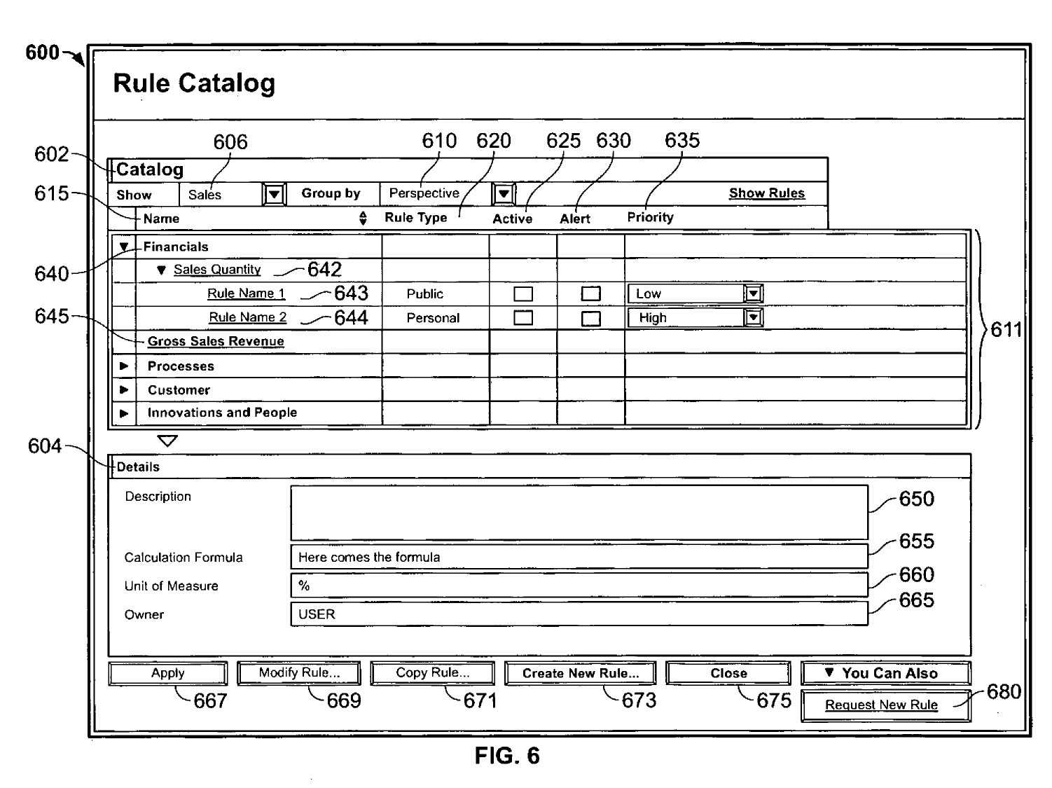

FIG. 6 is an exemplary screen snapshot 600 of an interface used to select rules to apply to a performance view request, according to one implementation. The snapshot 600 contains two main window components: a catalog section 602 that contains names, types, and groupings of rules, and a details section 604 that contains details about a rule selected in the catalog section 602. In general, when requesting a performance view, a user may begin by first selecting the enterprise division (such as “sales”), and then proceed by applying rules to the key areas for which they are interested. In this example, the user has selected a “sales” division, as evidenced by the catalog selection “sales” 606 that may be selected from a drop-down list of enterprise divisions.

Upon selecting the “sales” division 606, stored rules may appear by different grouping techniques; in this example, the rules are listed by perspective 610. The rules may appear in a table 611 according to hierarchical function, and may be expanded according to their dependency. For example, rules under the “financials” heading 640 may be expanded to include “sales quantity” 642, which may further be expanded to “rule 1” 643, “rule 2” 644, etc. These stored rules may have associated rule types 620, such as “public” or “personal,” and may be further classified according to the particular needs of the user. Examples of further rule classification include labeling as “active” 625, setting “alerts” 630, or assigning a priority to the rule 635 which may be integrated during the computation of the rule set applied to enterprise data collected.

The screen snapshot 600 has a highlighted section 645 representing a “Gross Sales Revenue” rule that has been configured by a user. The section 645 may be highlighted due to a user selecting the rule, such as by a mouse-over or mouse-click; selecting the rule has caused the details section 604 of the screen and its associated fields to become populated with details of the particular rule 645. In this example, descriptive elements include a description field 650, where a user may enter textual information relating to the rule, formulas 655, units of measure 660 and information about the owner of the rule 665, e.g., the creator of the rule. Users may make modifications to any of the fields and apply the changes by selecting the apply button 667; they may take further actions, including modifying (669), copying (671), and closing rules (675) as well as creating new rules (673).

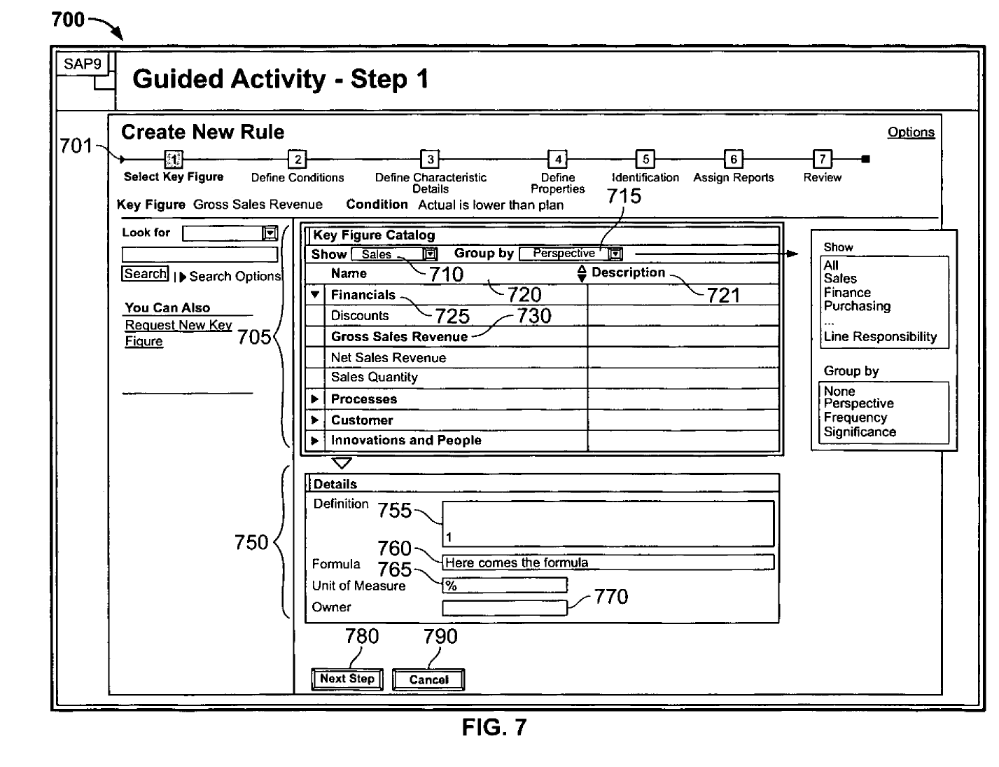

FIGS. 7-13 are exemplary screen snapshots of an interface that may be used to guide a user through the process of creating a new or custom rule. FIG. 7 is an exemplary screen snapshot 700 that may allow a user to select a key area for a new rule, according to one implementation. A user may visualize their progress in creating a new rule by referencing a graphical indicator 701 that highlights their current position along the series of steps. FIG. 7 may be the first of the screens 700 that the user may encounter, and comprises two main sections: a key figure catalog 705, and a details section 750. The key figures within the key figure catalog 705 may be presented when a user selects a business area from a pull-down list 710 that has been previously configured. The user may also group the key figures according to certain criteria, such as grouping by perspective 715. In this example screen snapshot 700, several key areas are listed in the key area catalog 705, including financials, processes, customer, and innovations and people. The user has selected Gross Sales Revenue 730 under the Financials key FIG. 725. Generally, the user may see details within key figures by expanding selections to their particular level of desired granularity.

By highlighting the Gross Sales Revenue section 730, the details section 750 of the screen 700 has been populated with several fields that the user may enter values into, including a general description 755, formula 760, unit of measure 765, and owner 770 areas. The user may enter appropriate information within these fields that may aid in identifying the rule according to these attributes at a later time. The user may proceed to the next step 780 or cancel the rule-making process 790 by clicking on the appropriate button(s).

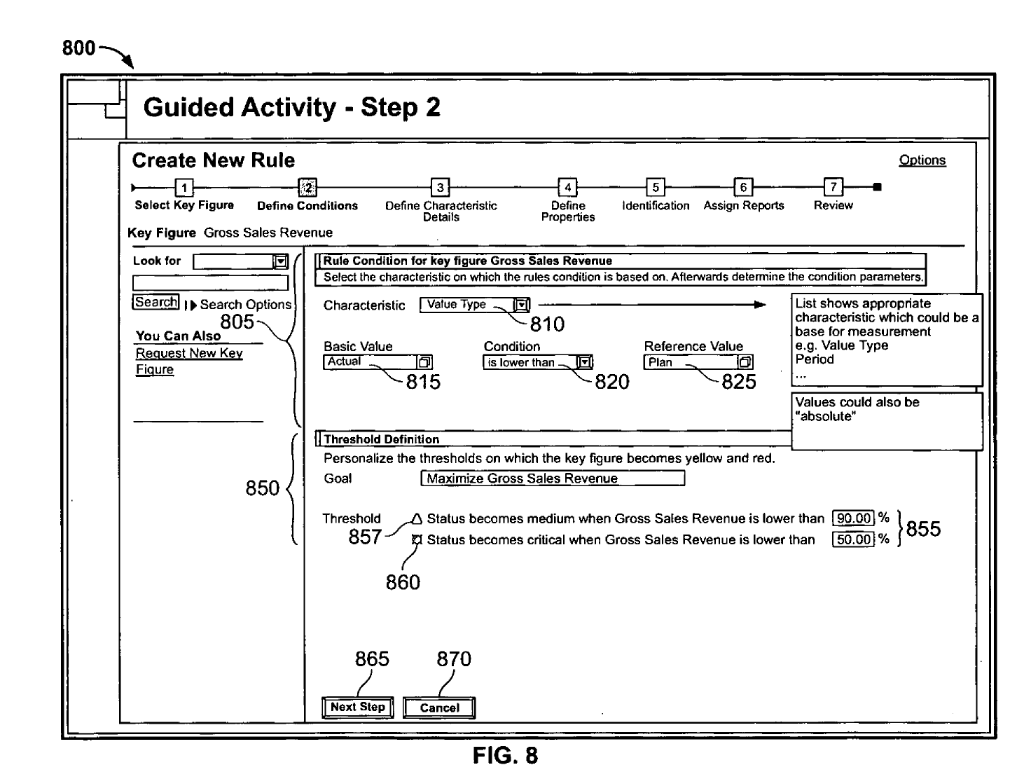

FIG. 8 is a screen snapshot 800 of the “define conditions” portion of setting up a custom or new rule, according to one implementation. The screen 800 consists of a Rule Condition section 805, where characteristics are applied to rules, and a Threshold Definition section 850 where a user may personalize the thresholds and visual indicators relating to rule thresholds. Characteristics (i.e., conditions which could be a basis for measurement) may be user selected, in this case from a drop-down list 810. Refinement of the condition may be accomplished by further imposing limits on the condition through user-selection of conditions, or by filling in fields related to user-selected variables. In this example screen snapshot 800, the user has been presented with three user-selectable fields containing characteristics which will be applied to the measurement: Basic Value 815, Condition 820, and Reference Value 825. In this example, combining the available conditions, it is evident that the user wishes to apply the condition “Value type (actual) is lower than plan” as a rule condition.

Below the rule condition area 805 the user may have an additional area containing options for defining threshold definitions 805. In this example screen snapshot 800, the user may have chosen customizable alerts when the threshold values of the rule fall above or below certain limits. The threshold area 855 contains two alerts, and the user may have chosen specific GSR values that identify performance problems for the business area: a “medium” status level (GSR lower than 90%) 857, and a “critical” level (GSR lower than 50%) 860. Alternatively, the user may set an “outperforming expectations” indicator when GSR is above 97% (not shown). Users may assign multiple threshold definitions (variants) to be utilized in calculating performance. After setting the appropriate values in the rule condition 805 and threshold definition 850 areas, the user may continue to the next step 865 or cancel the process 870.

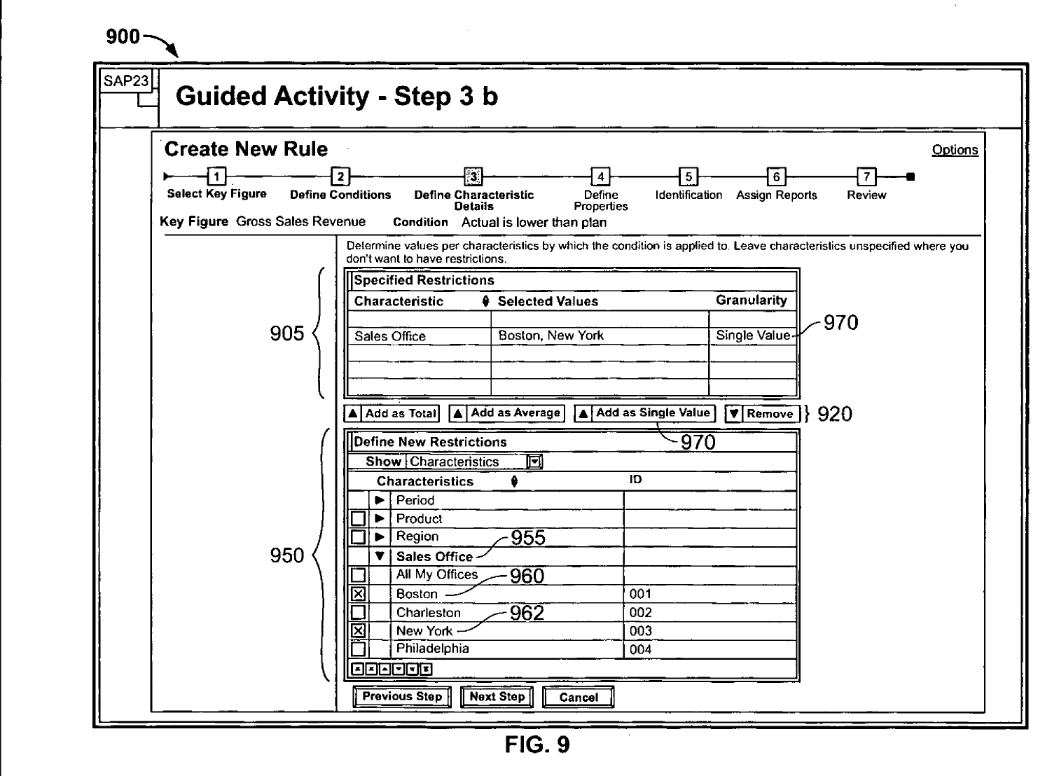

FIG. 9 is a screen snapshot 900 of a “define characteristic details” portion of setting up a new rule, according to one implementation. In this section, the user may determine values, as in section 905, for the characteristics by which the condition is applied to. The user may elect to define new restrictions, as in section 950; in this example screen snapshot 900, the user has selected “Boston” 960 and “New York” 962 from the “Sales Office” 955 characteristic list and added it to the specified restrictions list 905 using the “Add as Single Value” button 970. The “Boston” 960 and “New York” 962 characteristics may then appear in the specified restrictions list 905 as an individual entry 970. In this example, the user may perform operations on elements between the “specified restrictions” section 905 and the “define new restrictions” section 950 through use of user-selected buttons 920.

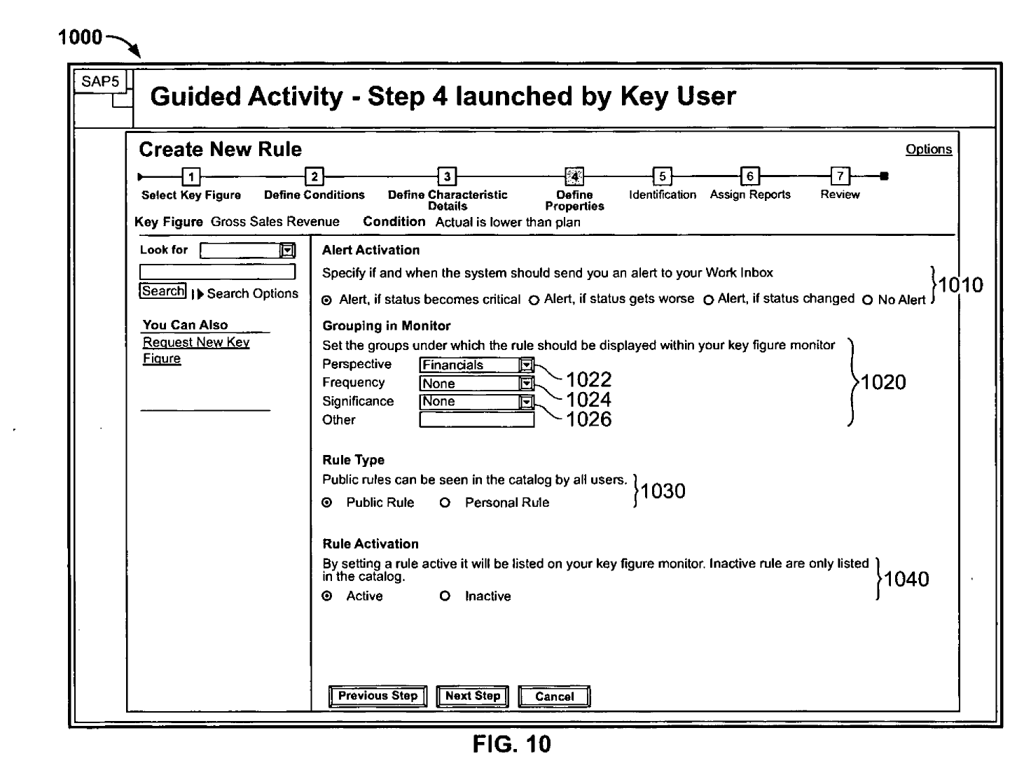

FIG. 10 is a screen snapshot 1000 of a “define properties” portion of setting up a new rule, according to one implementation. The “Alert Activation” section 1010 may allow a user to set the alert parameters of a performance view request through pre-defined, user-selectable options. In this example screen snapshot 1000, the user has requested that an alert be sent if the status of a characteristic becomes critical, as in FIG. 8, 860. Section 1020 may allow a user to set the groups under which the rule may be displayed within a key figure monitor (discussed below). The user may select options such as ‘Perspective’ 1022, ‘Frequency’ 1024, or ‘Significance’ 1026. ‘Frequency’ 1024 can define, for example, availability of meaningful data, e.g., a closed period, or it can reflect a meeting schedule, e.g., weekly team meetings, monthly executive meetings, and the like. The rule may be made public, such that the rule may be seen in the rule catalog by all users, or it may be kept private, such that only the creator of the rule may access it, by selecting the appropriate radial button in section 1030. Likewise, the rule may be set to active or inactive, allowing the rule to be listed on a rule catalog 602 by selecting the appropriate radial button in section 1040.

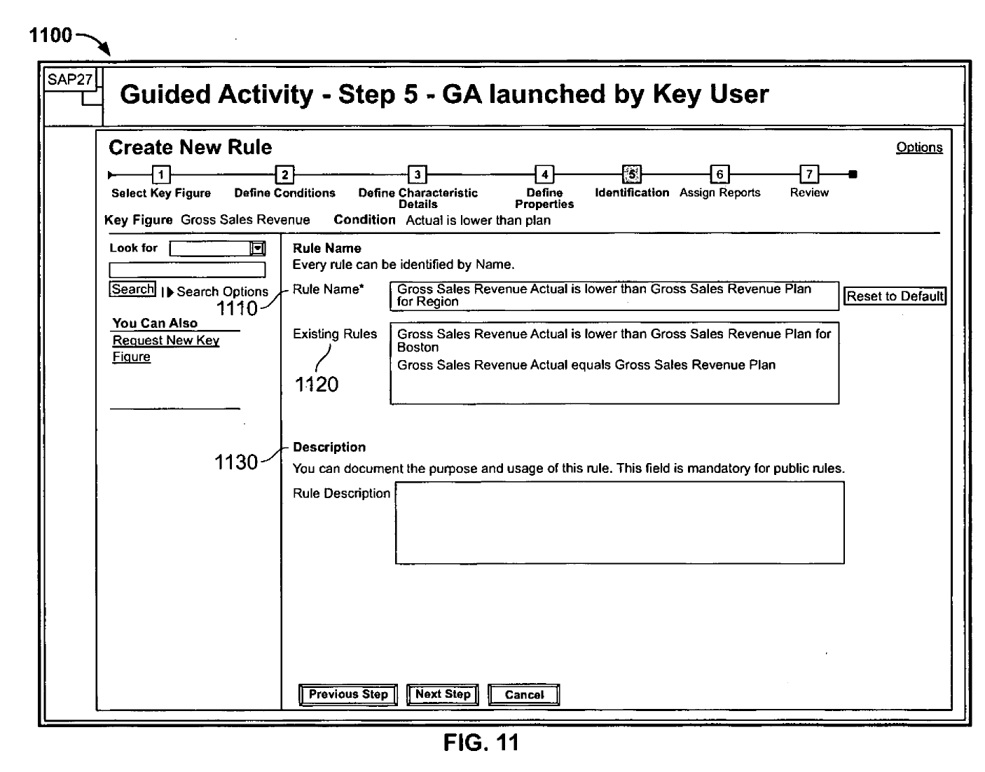

FIG. 11 is a screen snapshot 1100 of an “identification” portion of setting up a new rule, according to one implementation. This section may allow a user to define a rule name 1110 by entering a description of the rule. Existing rules may be displayed, as in section 1120 to aid the creator in a naming scheme. A description area 1130 may allow a creator to document purpose and usage of the rule, which may be beneficial to other users if it is made public.

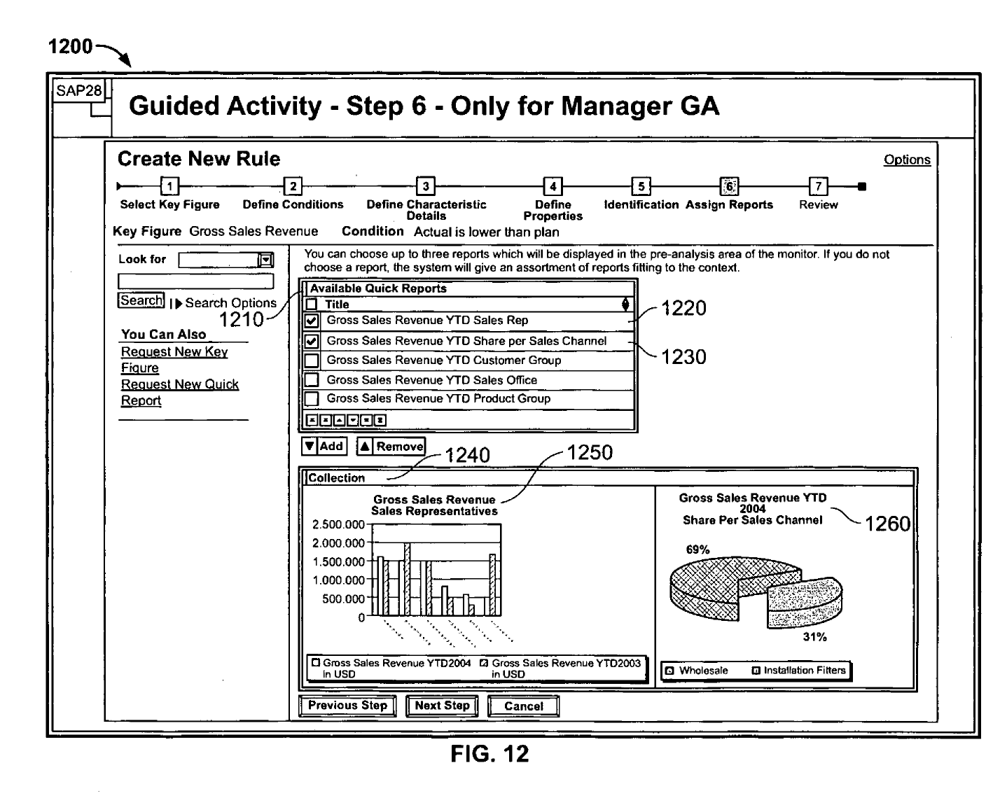

FIG. 12 is a screen snapshot 1200 of an “assign reports” portion of setting up a new rule, according to one implementation. This section may allow a user to choose “quick reports” 1210 which may be generated with a requested performance view, and may consist of graphical depictions of business performance. For example, in this screen snapshot 1200, the user has selected “Gross Sales Revenue YTD Sales Rep” 1220 and “Gross Sales Revenue YTD Share per Sales Channel” 1230 quick reports. The user may add these reports to the collection section 1240, which may make them available in the generated performance view. In this example, a bar chart 1250 represents the current performance of “Gross Sales Revenue YTD Sales Rep” 1220, and a pie chart 1260 represents the current performance of “Gross Sales Revenue YTD Share per Sales Channel” 1230, however, the attributes of the graphical depictions of business performance may be a user-customizable feature.

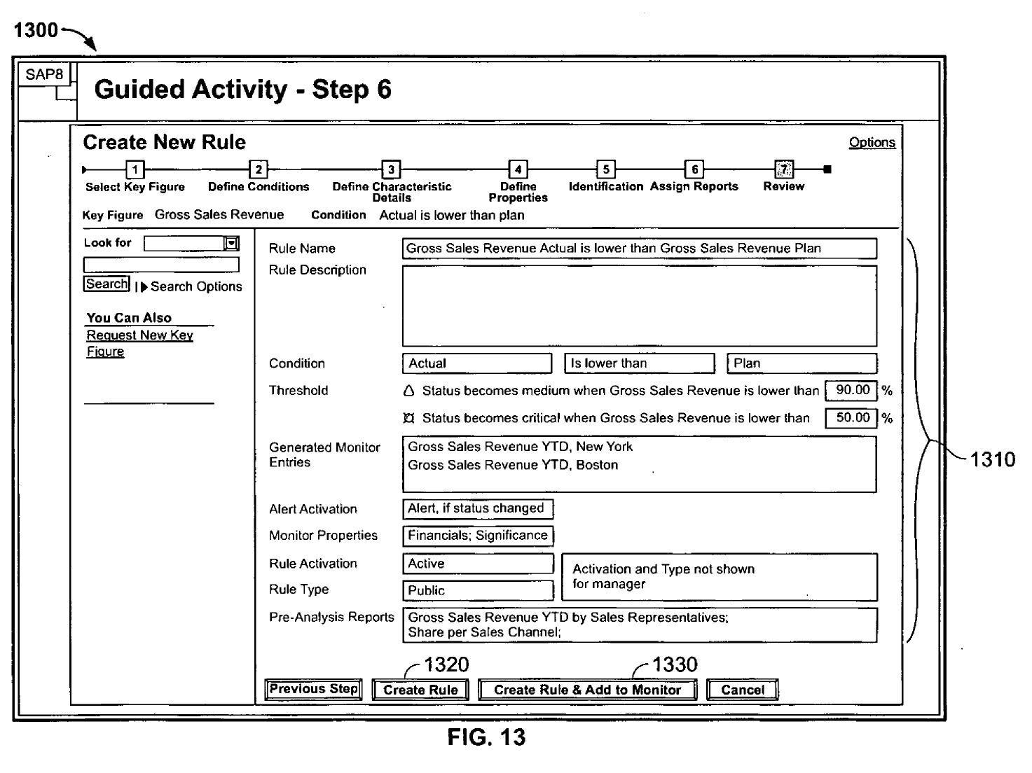

FIG. 13 is a screen snapshot 1300 of a “review” portion of setting up a new rule, according to one implementation. The screen may comprise a section 1310 that summarizes all or a portion of the attributes that were entered or selected so that the user may review their rule before creating it. When the user is content with the new rule, the user may create the rule, adding it to the repository of rules 132 by selecting the ‘create rule’ button 1320. The WPV module 120 can automatically differentiate between personal and public rules within the repository 132, according to the rule settings.

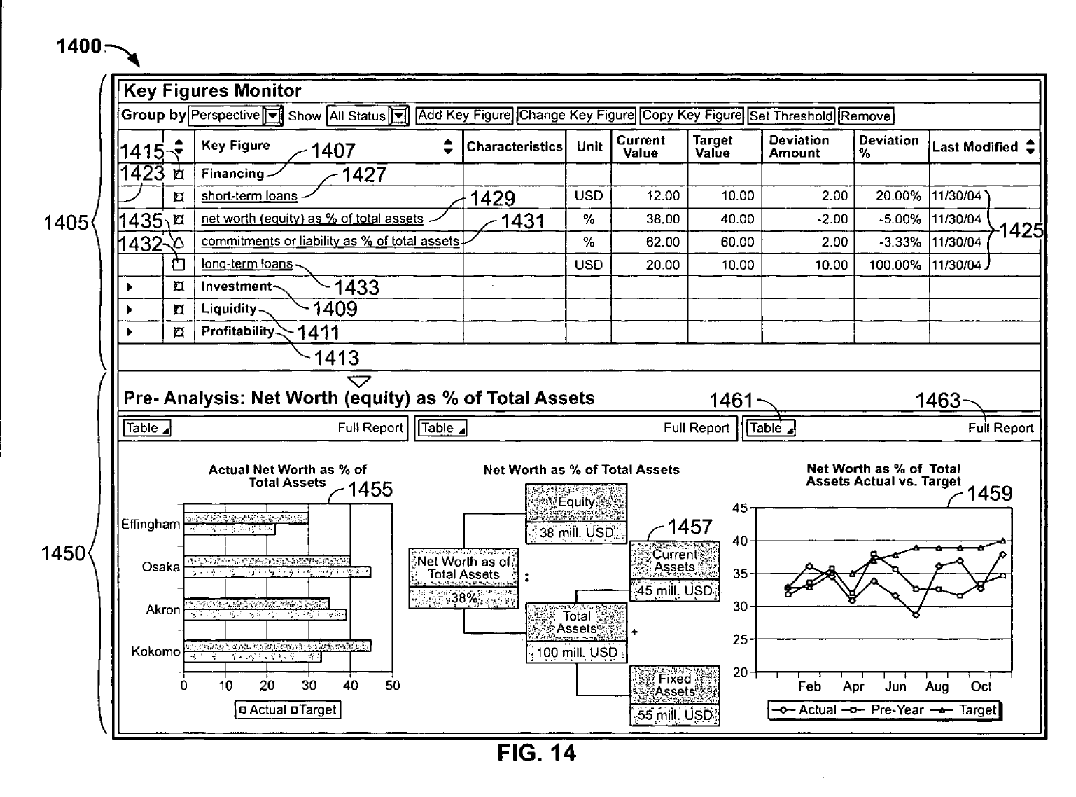

FIG. 14 is a screen snapshot 1400 of an exemplary performance view, according to one implementation. The snapshot 1400 may have been generated according to the sequence of events in the flowchart 400 in FIG. 4 for a particular enterprise area, for example, and represents a preferred embodiment of a performance view.

The screen snapshot 1400 contains two sections, a key figures monitor 1405 and a pre-analysis section 1450. The key figures monitor 1405 may contain easily identifiable performance information for user-selected key areas, which may have been selected at steps 420 and 430 of FIG. 4. The pre-analysis area 1450 may contain graphical depictions of performance data, which may have been selected in the rules setup sequence 350 at step 560 (FIG. 5) (see also the “assign reports” screen snapshot 1200 of FIG. 12).

The exemplary performance view screen snapshot 1400 contains four key figure areas which the user has chosen to monitor: financing 1407, investment 1409, liquidity 1411, and profitability 1413. Beside each key figure area may exist a graphic icon that the user may reference to easily identify current performance indications, making it possible to identify problematic enterprise areas at a glance. For example, the star 1415 beside the financing 1407 key area may indicate to the user that, overall, the financing key area 1407 is not meeting performance expectations. Based on personal preferences, the user may select the type of icon or indicator to represent varying levels of performance. In this example, the remaining three key areas may be suffering similar issues, as they show the same performance level indicator as financing 1407.

While a user may quickly reference the overall performance of a key area, it may be beneficial to drill down into the details of the key area to understand why the sector is falling below expectations. A user may expand the key area 1407, for example, by clicking on an icon 1423. The key figure monitor 1405 may then expand to show details of a key area 1425, in which each detail section 1425 may contain its own individual performance indicator(s). In this example, the user has expanded the financing 1407 key area to show four detail areas 1425 that may fall under the jurisdiction of a financing department within an enterprise. As noted by the graphical indicator, two elements of the finance key area 1407 are falling below performance expectations: ‘short term loans’ 1427 and ‘net worth (equity) as a % of total assets’ 1429. Determination of the performance factor may be set forth in the rules definitions provided by the user prior to executing the request for a performance view, such as in the ‘define conditions’ screen snapshot 800 of FIG. 8.

The remaining key area details, ‘commitments or liability as % of total assets’ 1431 and ‘long term loans’ 1433 may be performing at a higher level as noted by the triangle 1435, which may represent “average” or “expected” performance, for example, and the square 1432, which may represent “higher than expected” performance. The overall calculation of the financing key figure area 1407 (and indicator 1415) may result from weighting the performance of the key area elements 1425 according factors that may be defined by the user. For example, the enterprise may regard ‘long term loans’ 1433 as a particularly important factor in calculating the overall performance of the financing key area 1407. Given enough weight in the performance calculation, the higher than expected performance value shown in this example could outweigh the other key area details, which are currently underperforming, such that the financing key area 1407 showed a favorable performance evaluation (not indicated).

Essential figures or characteristics in evaluating key are performance may also be presented within the key figure monitor 1405, such that the user may reference not only the sector's performance, but also the details of why the performance was rated as it was. User-definable fields, as entered, for example in the ‘define conditions’ screen snapshot 800 of FIG. 8, and the respective enterprise data collected during run-time, may indicate the cause of the performance evaluation. For example, the ‘net worth (equity) as a % of total assets’ 1427 key area detail indicates a deviation of −5% between its current value of 38, and the target value of 40, resulting in the performance indicating graphic shown 1437. Likewise, the ‘long term loans’ 1433 key area figure is over-performing expectations by 100%, as its current value (USD $20) is double that of the expected value (USD $10). Being able to realize the cause of a poor performance rating with a quick glance at the numerical details of key figure data may be highly beneficial to the user.

Another benefit to the user may be the ability to graphically visualize key figure data that is used in performance calculations. The contents of the pre-analysis window 1450 may change according to user-selection of a key area (e.g., ‘financing’ 1407), or one of the key area details 1425. Users may select the type and style of graphically depicted data that may be shown in the pre-analysis area 1450, for example, during the set-up of a rule, as in FIG. 12 in the ‘available quick reports’ section 1210.

In this example screen snapshot 1400, the user has chosen to view graphic depictions of performance data regarding the ‘net worth (equity) as a % of total assets’ key figure element 1429, as evidenced by the shading of the row within the key figures detail group 1425. The user may then be presented with charts, graphs, and other similar data presentation methods in the pre-analysis window 1450. In this example, the user may visualize three charts regarding net worth (charts 1455, 1457, and 1459) which they may have chosen during the set-up of a custom or stored rule. Offering extended flexibility, the user may select an individual chart, e.g., the ‘Net worth as % of Total Assets Actual vs. Target’ 1459, which is currently a line chart, and present the data in an alternative expression. This may be accomplished, for example, by selecting the “table” button 1461, which may present the user with data in a tabular format, such as the graph 1459. Likewise, the user may select the “full report” button 1463 which may present the user with an extended graphical data analysis concerning the data for this particular key area detail.

The performance view 1400 may allow a user to view performance indications of enterprise key figure areas at a granularity of their choosing. In some instances, a user may simply require a high-level overview of the performance of their enterprise area, in which the contents of the key figures monitor 1405 and pre-analysis 1450 windows may provide such high-level representations of performance. In situations where a user desires to view detailed data relating to the performance of a key figure area, and/or subordinate key figure areas within the hierarchy of the enterprise, they may do so by navigating to the full report and using ‘drilling-down’ within the key figure areas.

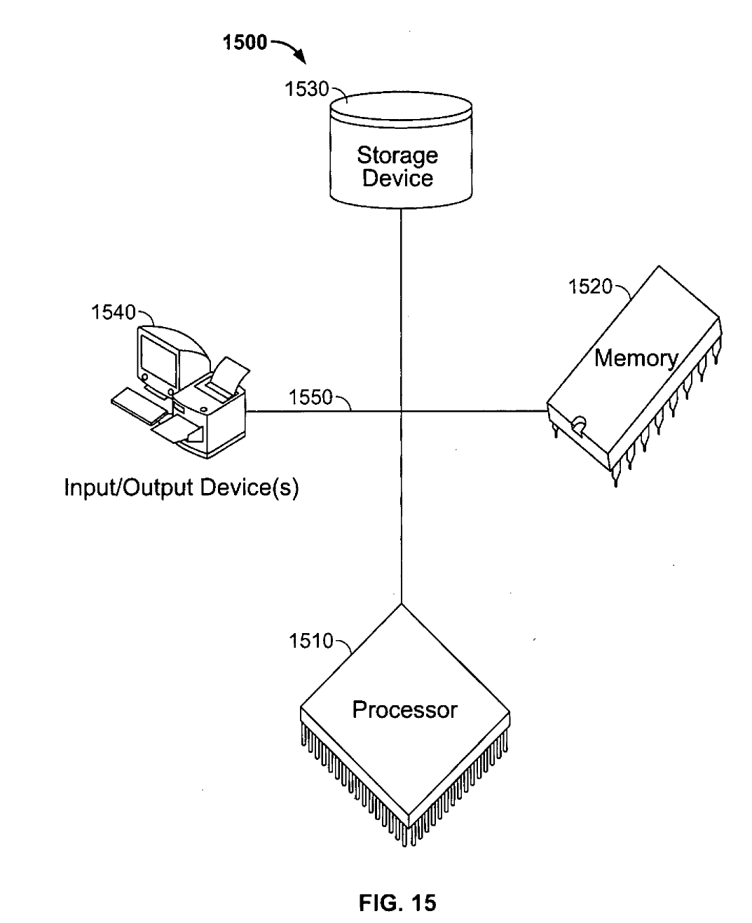

FIG. 15 is a schematic diagram of a generic computer system that may be used to implement the methods described, according to one implementation. The system 1500 includes a processor 1510, a memory 1520, a storage device 1530, and an input/output device 1540. Each of the components 1510, 1520, 1530, and 1540 are interconnected using a system bus 1550. The processor 1510 is capable of processing instructions for execution within the system 1500. In one implementation, the processor 1510 is a single-threaded processor. In another implementation, the processor 1510 is a multi-threaded processor. The processor 1510 is capable of processing instructions stored in the memory 1520 or on the storage device 1530 to display graphical information for a user interface on the input/output device 1540.

The memory 1520 stores information within the system 1500. In one implementation, the memory 1520 is a computer-readable medium. In one implementation, the memory 1520 is a volatile memory unit. In another implementation, the memory 1520 is a non-volatile memory unit.

The storage device 1530 is capable of providing mass storage for the system 1500. In one implementation, the storage device 1530 is a computer-readable medium. In various different implementations, the storage device 1530 may be a floppy disk device, a hard disk device, an optical disk device, or a tape device.

The input/output device 1540 provides input/output operations for the system 1500. In one implementation, the input/output device 1540 includes a keyboard and/or pointing device. In another implementation, the input/output device 1540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for configuring a process to be executed to provide a visual display showing performance information for an organization, the method comprising:
receiving user-initiated input that identifies an area within an organization and a type of information that is applicable to the identified organization area and for which a performance information visual display is to be provided;
receiving user-initiated input that defines a rule to be executed in providing the performance information display, the rule comprising an identification of a source for data to be retrieved relating to the identified type of information for the identified organization area, a definition of one or more performance measures against which the data retrieved from the data source are to be measured, and a definition for a display layout for the performance information display;
electronically storing the defined rule in association with the identified organization area and the identified type of information, for use in generating the performance information display.

2. The method of claim 1, wherein the data source comprises a specified electronic document in which at least a portion of the data relating to the identified type of information for the identified organization area are stored during operations of the organization area.

3. The method of claim 2, wherein the data source further comprises a specified portion of the specified electronic document.

4. The method of claim 2, wherein the specified electronic document complies with a predefined format that ensures relevant data are stored in the specified electronic document during operations of the organization area.

5. The method of claim 1, wherein the performance measures comprise a limit boundary that defines a limit for different specified performance levels.

6. The method of claim 5, wherein the limit boundary is a target performance level, and the different specified performance levels indicate a performance achieved in comparison with the target performance level.

7. The method of claim 1, wherein the display layout is a graphical representation for the retrieved data from the identified data source as compared with the defined one or more performance measures.

8. The method of claim 7, wherein the performance measures comprise a limit boundary that defines a limit for different specified performance levels.

9. The method of claim 8, wherein the limit boundary is a target performance level, and the different specified performance levels indicate a performance achieved in comparison with the target performance level.

10. A computer-implemented method for generating a visual display showing performance information for an organization, the method comprising:
receiving user-initiated input that requests a performance visual display be provided for an area within an organization and a type of information that is applicable to the identified organization area for which a performance information visual display has been pre-configured;
retrieving data relating to the type of information for the organization area from a predefined data source; and
generating, on a display device, a visual display of the retrieved data measured against one or more predefined performance measures and within a predefined display layout for the performance information display.

11. The method of claim 10, wherein the data comprises a specified electronic document in which at least a portion of the data relating to the identified type of information for the identified organization area are stored during operations of the organization area.

12. The method of claim 11, wherein the data source further comprises a specified portion of a specified electronic document.

13. The method of claim 11, wherein the specified electronic document complies with a predefined format that ensures relevant data are stored in the specified electronic document during operations of the organization area.

14. The method of claim 10, wherein the performance measures comprise a limit boundary that defines a limit for different specified performance levels.

15. The method of claim 14, wherein the limit boundary is a target performance level, and the different specified performance levels indicate a performance achieved in comparison with the one or more predefined performance measures.

16. The method of claim 10, wherein the visual display is a graphical representation for the retrieved data from the predefined data source as compared with the defined one or more performance measures.

17. The method of claim 16, wherein the performance measures comprise a limit boundary that defines a limit for different specified performance levels.

18. The method of claim 17, wherein the limit boundary is a target performance level, and the different specified performance levels indicate a performance achieved in comparison with the one or more predefined performance measures.

19. The method of claim 10, wherein the visual display of the retrieved data is presented in a universal display format, independent of a user's hierarchical standing within the organization that requests the performance visual display.

20. A computer program product tangibly embodied in an information carrier, the computer program product including instructions that, when executed, perform operations for configuring a process to be executed to provide a visual display showing performance information for an organization, the method comprising:
receiving user-initiated input that identifies an area within an organization and a type of information that is applicable to the identified organization area and for which a performance information visual display is to be provided;
receiving user-initiated input that defines a rule to be executed in providing the performance information display, the rule comprising an identification of a source for data to be retrieved relating to the identified type of information for the identified organization area, a definition of one or more performance measures against which the data retrieved from the data source are to be measured, and a definition for a display layout for the performance information display;
electronically storing the defined rule in association with the identified organization area and the identified type of information, for use in generating the performance information display.
